(19) United States
(12) Patent Application Publication
(10) Pub. No.: US 2025/0174681 A1
(43) Pub. Date: May 29, 2025

(54) Method for connecting a first bipolar plate layer and a second bipolar plate layer by a material joint, bipolar plate for an electrochemical unit of an electrochemical device and electrochemical device

(71) Applicant: EKPO Fuel Cell Technologies GmbH, Dettingen (DE)

(72) Inventors: Michael SCHAICH, Dettingen (DE); Arno BAYER, Dettingen (DE)

(21) Appl. No.: 19/040,408

(22) Filed: Jan. 29, 2025

Related U.S. Application Data
(63) Continuation of application No. PCT/EP2023/069824, filed on Jul. 17, 2023.

(30) Foreign Application Priority Data
Aug. 1, 2022 (DE) 10 2022 119 222.9

(51) Int. Cl. H01M 8/0297

(52) U.S. Cl. CPC H01M 8/0297

(57) ABSTRACT

In order to create a method for connecting, by a material joint, a first bipolar plate layer and a second bipolar plate layer of a bipolar plate for an electrochemical unit of an electrochemical device comprising a plurality of electrochemical units that follow one another along a stack direction, wherein the method comprises the following:
bringing the first bipolar plate layer and the second bipolar plate layer into contact with one another at one or more contact regions of the bipolar plate layers;
applying a clamping force to the first bipolar plate layer and the second bipolar plate layer by means of one or more clamping tools; and
connecting the first bipolar plate layer and the second bipolar plate layer by a material joint along a connection seam;
   which method makes it possible to reliably connect the two bipolar plate layers to one another without deteriorating the flow properties of the bipolar plate or impairing the supporting function of the bipolar plate for parts of the electrochemical units of the electrochemical device, it is proposed that at least one clamping tool is supported on a supporting face of at least one support structure of at least one of the bipolar plate layers, wherein the supporting face of the support structure, relative to the surface of the bipolar plate layer on which the support structure is formed, is offset in the contact region along the stack direction away from the respective other bipolar plate layer.

### RELATED APPLICATIONS

This application is a continuation of international application number PCT/EP2023/069824 filed on 17 Jul. 2023 and claims the benefit of German application number 10 2022 119 222.9 filed on 1 Aug. 2022.

The present disclosure relates to the subject matter disclosed in international application number PCT/EP2023/069824 of 17 Jul. 2023 and German application number 10 2022 119 222.9 of 1 Aug. 2022, which are incorporated herein by reference in their entirety and for all purposes.

### FIELD OF THE DISCLOSURE

The present invention relates to a method for connecting, by a material joint, a first bipolar plate layer and a second bipolar plate layer of a bipolar plate for an electrochemical unit of an electrochemical device comprising a plurality of electrochemical units that follow one another along a stack direction, wherein the method comprises the following:
bringing the first bipolar plate layer and the second bipolar plate layer into contact with one another at one or more contact regions of the bipolar plate layers;
applying a clamping force to the first bipolar plate layer and the second bipolar plate layer by means of one or more clamping tools; and
connecting the first bipolar plate layer and the second bipolar plate layer by a material joint along a connection seam.

The connection seam is hereby preferably produced by welding, in particular by laser welding.

For producing such a connection seam, a specially adapted and highly precise welding tool is required, which comprises clamping tools for applying a clamping force to the first bipolar plate layer and the second bipolar plate layer so that the first bipolar plate layer and the second bipolar plate layer are spaced apart from one another by merely a “technical zero gap” with a height (along the stack direction of the electrochemical device) of less than 0.03 mm in the contact regions in which the bipolar plate layers are to be connected to one another. For this purpose, for example, clamping tools configured as clamping webs must be placed against flat regions of the bipolar plate layers on both sides of the connection seam to be produced in order to a achieve a sufficient clamping effect.

The connection seams and the flat regions of the bipolar plate layers that have to be kept clear on both sides of the connection seams require a significant proportion of the total space available on the bipolar plate, which is disadvantageous with respect to development and design, because a large amount of space is required for the arrangement of elements introduced into the bipolar plate layers by reshaping, which elements direct the flow of media to be supplied to the electrochemical device (anode gas, cathode gas, coolant) and/or support parts of electrochemical units adjacent to the bipolar plate, for example gas diffusion layers or parts of sealing arrangements of the electrochemical units.

Too large flat regions of the bipolar plate layers to be connected to one another that have to be kept clear for the arrangement of clamping tools negatively influence the flow properties of the bipolar plate.

In accordance with an embodiment of the invention, a method for connecting, by a material joint, a first bipolar plate layer and a second bipolar plate layer of a bipolar plate for an electrochemical unit of an electrochemical device of the kind stated at the outset is provided, which makes it possible to reliably connect the two bipolar plate layers to one another without deteriorating the flow properties of the bipolar plate or impairing the supporting function of the bipolar plate for constituent parts of the electrochemical units of the electrochemical device.

### SUMMARY OF THE INVENTION

In accordance with an embodiment of the invention, a method for connecting, by a material joint, a first bipolar plate layer and a second bipolar plate layer of a bipolar plate for an electrochemical unit of an electrochemical device is provided, said method having the features of the preamble of claim 1, wherein at least one clamping tool is supported on a supporting face of at least one support structure of at least one of the bipolar plate layers, wherein the supporting face of the support structure, relative to the surface of the bipolar plate layer on which the support structure is formed, is offset in the contact region along the stack direction away from the respective other bipolar plate layer.

Underlying the solution in accordance with the invention is the concept of using structures that are required anyway for directing the media flows and/or for supporting constituent parts of the electrochemical units, said structures preferably being molded into at least one of the bipolar plate layers, additionally for supporting at least one clamping tool during the production of a connection seam between the first bipolar plate layer and the second bipolar plate layer of the bipolar plate.

The at least one support structure is designed such that it has a supporting face for supporting a clamping tool during the production of the connection seam, wherein this supporting face may preferably also serve to support a component of an electrochemical unit adjacent to the support structure, for example a gas diffusion layer or a constituent part of a seal arrangement of an electrochemical unit.

The height of the support structure, i.e. the distance of the supporting face from the surface of the bipolar plate layer on which the support structure is formed, in a contact region in which said bipolar plate layer abuts, preferably in surface-to-surface contact, against the respective other bipolar plate layer, is adapted to the adjacent component of an electrochemical unit that is to be supported, for example a membrane electrode arrangement.

The shape, in particular the outer contour, of the support structure is optimized for the production process of the connection seam.

Thus, space can be saved on the bipolar plate, which would otherwise have to be kept clear for the arrangement of clamping tools during the production of the connection seams.

The at least one support structure may have, for example, the form of a bowl or a “dimple” with a circular, oval, or free-form rim.

Here, the rim of a support structure is a line at which the support structure transitions into a planar region oriented in parallel to the stack direction.

Such a support structure may be arranged on an anode-side bipolar plate layer or on a cathode-side bipolar plate layer.

Preferably, such a support structure is formed by a reshaping operation on one of the bipolar plate layers, for example by a stamping operation or a deep-drawing operation.

The greatest extent of such a support structure along a direction running perpendicularly to the stack direction is preferably about 3 mm to about 7 mm, for example about 5 mm.

Such a support structure may be formed on one side on the anode-side bipolar plate layer or on the cathode-side bipolar plate layer, wherein the respective other bipolar plate layer in the corresponding region has a planar free area against which a clamping tool is able to abut during the production of a connection seam.

Alternatively hereto, provision may also be made that a, preferably bowl-shaped, support structure is also formed on the respective other bipolar plate layer, which, when viewed along the stack direction of the electrochemical device, is of substantially congruent configuration with the support structure on the first bipolar plate layer or is only slightly offset from the support structure on the first bipolar plate layer. As a result of the deformation of the support structures arranged in the same position on the two bipolar plate layers to be connected to one another, the pressing of these support structures by means of the clamping tools, which are brought into contact with the support structures, a balance of forces is achieved, according to which the forces generated by the bipolar plate layers onto one another and onto the clamping tools are equal to one another (“action equals reaction”).

Alternatively or in addition hereto, provision may also be made that at least one web structure is formed in the shape of a web on at least one of the bipolar plate layers to be connected to one another and extends substantially in parallel to the connection seam.

A contact surface formed on such a web-shaped support structure preferably has an extent perpendicular to the stack direction of less than 3 mm, particularly preferably less than 1.5 mm.

Such a web-shaped support structure may be arranged on one side only on an anode-side bipolar plate layer or only on a cathode-side bipolar plate layer, wherein the respective other bipolar plate layer in this region has a planar free area against which a clamping tool is able to be placed during the production of the connection seam.

Alternatively or in addition hereto, provision may also be made that the respective other bipolar plate layer is also provided with a second web-shaped support structure, which, relative to the contact plane of the two bipolar plate layers, is configured symmetrically to the first web-shaped support structure or deviates only slightly from its form. Preferably, the position of the second web-shaped support structure, when viewed along the stack direction, is substantially congruent with the position of the first web-shaped support structure or is offset only slightly from the position of the first web-shaped support structure.

The rims of the support structures at which the support structures transition into a planar region of the respective bipolar plate layer preferably meet on both opposite sides of the web-shaped support structure, such that the two bipolar plate layers abut against one another “on block”. As a result, upon the pressing of the web-shaped support structures by means of the clamping tools during the production of the connection seams, a balance of forces is achieved, in which the forces exerted by the bipolar plate layers on one another and on the clamping tools are equal to one another (“action equals reaction”).

In a further embodiment of the invention, provision is made that one of the bipolar plate layers to be connected to one another has a plurality of web-shaped support structures, which extend transversely to the connection seam and end at a small distance from the connection seam.

Here, the respective other bipolar plate layer in the region of these terminating web-shaped support structures may have a planar free area against which a clamping tool is able to be placed during the production of the connection seam.

Alternatively hereto, provision may also be made that the respective other bipolar plate layer has one or more web-shaped support structures extending substantially in parallel to the connection seam in the region in which the first bipolar plate layer has web-shaped support structures extending transversely to the connection seam.

Here, the rims of the support structures preferably meet in the region between the web-shaped support structures of the first bipolar plate layer that extend transversely to the connection seam, and on the side of the web-shaped support structures of the second bipolar plate layer facing away from the connection seam in such a way that the two bipolar plate layers abut against one another “on block” at these locations. As a result, upon the pressing of the support structures during the production of the connection seam, a balance of forces is achieved, in which the forces exerted by the bipolar plate layers on one another and on the clamping tools are equal to one another (“action equals reaction”).

The rim of a support structure at which the support structure transitions into a planar region of the bipolar plate layer is preferably at a distance from the connection seam which is smaller than 1 mm, in particular smaller than 0.5 mm, particularly preferably smaller than 0.1 mm.

On a side of the support structure facing away from the connection seam, the rim of the support structure formed on one of the bipolar plate layers preferably meets the rim of a further support structure formed on the respective other bipolar plate layer in order to achieve that the bipolar plate layers, at this portion of their rims, abut against one another “on block” to achieve a sufficient supporting effect due to the balance of forces produced here (“action equals reaction”).

These portions of the rims of the support structures that face away from the connection seam are preferably at a distance from the connection seam which is greater than 1 mm and/or smaller than 5 mm.

The at least one support structure of the bipolar plate produced in accordance with the invention makes it possible on the one hand to arrange a clamping tool very close to a connection seam during the production of the connection seam. On the other hand, the at least one support structure may serve to support an adjacent component of an electrochemical unit, for example a gas diffusion layer or a structural element of a seal arrangement of an electrochemical unit.

The at least one support structure is designed as a stable element for absorbing the clamping force of the clamping tools during the production of the connection seam and is placed as close as possible to the connection seam.

The at least one support structure formed on one of the bipolar plate layers is preferably supported, both on its side facing toward the connection seam and on its side facing away from the connection seam, on a support structure formed on the respective other bipolar plate layer.

As a result of the exertion of a clamping force by means of clamping tools on the support structures of the bipolar plate, the bipolar plate layers to be connected to one another are spaced apart from one another only by a small gap which has a height (along the stack direction) that is smaller than 0.03 mm in the contact region in which they abut, preferably in surface-to-surface contact, against one another and are to be connected to one another by a connection seam.

The supporting effect of the support structures ensures that, during the operation of the electrochemical device, the component of an electrochemical unit supported on the support structure, for example a gas diffusion layer, a sub-gasket, or another element of a seal arrangement of an electrochemical unit, does not penetrate into the interspace between a medium distribution region and a medium passage opening of the bipolar plate and thereby close media outlets of sealing beads or close a medium distribution region.

In a preferred embodiment of the invention, provision is made that at least one of the clamping tools is supported on a plurality of supporting faces of a plurality of different support structures and on a plurality of contact regions of the bipolar plate layers located between the support structures.

Provision is preferably made that at least one first clamping tool is supported on at least one first support structure formed on the first bipolar plate layer, and at least one second clamping tool is supported on at least one second support structure formed on the second bipolar plate layer.

The first support structure has a rim at which the first support structure transitions into a planar region of the first bipolar plate layer, and the second support structure has a second rim at which the second support structure transitions into a planar region of the second bipolar plate layer.

Here, the first rim and the second rim are preferably substantially congruent with one another or preferably deviate from one another by a distance of at most 0.5 mm in a projection onto a plane preferably oriented perpendicularly to the stack direction. This distance is preferably measured perpendicularly to the longitudinal direction of the first rim or perpendicularly to the longitudinal direction of the second rim.

In a particular embodiment of the invention, provision is made that at least one support structure is formed at a location of one of the bipolar plate layers, located opposite to which is a planar region of the respective other bipolar plate layer not provided with a support structure.

The supporting face of at least one support structure preferably has a smallest extent (a) perpendicular to the stack direction which is at least 0.1 mm, in particular at least 0.5 mm.

Furthermore, the supporting face of at least one support structure preferably has a smallest extent (a) perpendicular to the stack direction which is at most 3 mm, in particular at most 1.5 mm.

Alternatively or in addition hereto, provision may be made that the supporting face of at least one support structure has a greatest extent perpendicular to the stack direction which is greater than 3 mm, in particular greater than 5 mm.

In a preferred embodiment of the invention, provision is made that at least one support structure has a rim at which the support structure transitions into a planar region of the bipolar plate layer on which the support structure is formed, wherein the smallest distance (d) of the rim of the support structure from the center line of the connection seam is at most 0.8 mm, in particular at most 0.5 mm, particularly preferably at most 0.3 mm.

Here, the smallest distance (d) of the rim of the support structure from the center line of the connection seam is preferably taken perpendicularly to the center line of the connection seam.

Provision is preferably further made that at least one support structure has a rim at which the support structure transitions into a planar region of the bipolar plate layer on which the support structure is formed, wherein the greatest distance (D) of the rim of the support structure from the center line of the connection seam is at most 5 mm, in particular at most 3 mm, particularly preferably at most 2 mm.

Here, the greatest distance (D) of the rim of the support structure is preferably taken perpendicularly to the center line of the connection seam.

At least one of the support structures may be of bowl-shaped configuration.

Provision may further be made that at least one support structure is of circular or oval configuration in a plan view along the stack direction.

Alternatively or in addition hereto, provision may be made that at least one support structure is of web-shaped configuration.

A web-shaped support structure may extend substantially in parallel to the connection seam at least in sections.

Alternatively or in addition hereto, provision may be made that a plurality of web-shaped support structures extend transversely to the connection seam and end at a distance (d′) from the center line of the connection seam of less than 0.8 mm, in particular less than 0.5 mm, particularly preferably less than 0.3 mm.

Here, the distance (d′) from the center line of the connection seam is preferably taken perpendicularly to the center line of the connection seam.

The present invention further relates to a bipolar plate for an electrochemical unit of an electrochemical device comprising a plurality of electrochemical units that follow one another along a stack direction, wherein the bipolar plate comprises the following:
a first bipolar plate layer and a second bipolar plate layer, which are connected to one another by a material joint along a connection seam in a contact region of the bipolar plate layers.

In accordance with an embodiment of the invention, a bipolar plate of the kind stated above is provided, in which the first bipolar plate layer and the second bipolar plate layer are reliably connectable to one another without the flow properties of the bipolar plate being deteriorated and without the function of the supporting of components of electrochemical units adjacent to the bipolar plate being impaired.

In accordance with an embodiment of the invention, a bipolar plate in accordance with claim 15 is provided, wherein at least one respective support structure is formed on the first bipolar plate layer and/or on the second bipolar plate layer,
wherein a supporting face of the at least one support structure, relative to the surface of the bipolar plate layer on which the support structure is formed, is offset in the contact region along the stack direction away from the respective other bipolar plate layer, and
wherein the at least one support structure has a rim at which the support structure transitions into a planar region of the bipolar plate layer on which the support structure is formed, wherein the smallest distance (d, d′) of the rim of the support structure from the center line of the connection seam is at most 0.8 mm, in particular at most 0.5 mm, particularly preferably at most 0.3 mm.

Here, the smallest distance (d, d′) of the rim of the support structure from the center line of the connection seam is preferably taken perpendicularly to the center line of the connection seam.

Particular embodiments of the bipolar plate have already been discussed in the preceding in connection with particular embodiments of the method in accordance with the invention for connecting, by a material joint, a first bipolar plate layer and a second bipolar plate layer of a bipolar plate for an electrochemical unit of an electrochemical device.

The method in accordance with the invention for connecting, by a material joint, a first bipolar plate layer and a second bipolar plate layer of a bipolar plate may be used, in particular, for connecting the bipolar plate layers of the bipolar plate in accordance with the invention by a material joint.

The bipolar plate in accordance with the invention may be produced, in particular, using the method in accordance with the invention for connecting a first bipolar plate layer and a second bipolar plate layer of a bipolar plate by a material joint.

The bipolar plate in accordance with the invention in suited, in particular, for use in an electrochemical device comprising a plurality of electrochemical units that follow one another along a stack direction and each comprise a respective bipolar plate in accordance with the invention.

Such an electrochemical device may be, for example, a fuel cell device or an electrolyzer.

For example, the electrochemical device may be configured as a polymer electrolyte membrane (PEM) fuel cell device.

Further features and advantages of the invention are subject matter of the subsequent description and the graphical representation of exemplary embodiments.

### BRIEF DESCRIPTION OF THE DRAWINGS

FIG. 1 shows a plan view of a bipolar plate for an electrochemical unit of an electrochemical device comprising a plurality of electrochemical units that follow one another along a stack direction,
wherein the bipolar plate comprises a first bipolar plate layer and a second bipolar plate layer, which are connected to one another by a material joint along a connection seam in a contact region of the bipolar plate layers,
wherein at least one respective support structure is formed on the first bipolar plate layer and/or on the second bipolar plate layer,
wherein a supporting face of the at least one support structure, relative to the surface of the bipolar plate layer on which the support structure is formed, is offset in the contact region along the stack direction away from the respective other bipolar plate layer, and
wherein the at least one support structure has a rim at which the support structure transitions into a planar region of the bipolar plate layer on which the support structure is formed, wherein the smallest distance, taken perpendicularly to the center line of the connection seam, of the rim of the support structure from the center line of the connection seam is at most 0.8 mm, with the viewing direction toward the anode side of the bipolar plate;

FIG. 2 shows a plan view of a left end region of the bipolar plate from FIG. 1;

FIG. 3 shows an enlarged depiction of the region I from FIG. 2;

FIG. 4 shows a sectional, partially cut depiction of the region of the bipolar plate from FIG. 3, cut along line 4-4 in FIG. 3;

FIG. 5 shows a partial plan view of a connection seam of the bipolar plate from FIG. 3 and support structures adjacent to the connection seam;

FIG. 6 shows a plan view of the end region of the bipolar plate from FIG. 2, with the viewing direction toward the cathode side of the bipolar plate;

FIG. 7 shows an enlarged depiction of the region II from FIG. 6;

FIG. 8 shows a partial longitudinal section through a web-shaped support structure of the bipolar plate, along line 8-8 in FIG. 7;

FIG. 9 shows an enlarged depiction of the region III from FIG. 6;

FIG. 10 shows a schematic section depiction, which shows how a clamping force is applied to the first bipolar plate layer and the second bipolar plate layer by means of a plurality of clamping tools, wherein the clamping tools are each supported on both sides of a connection seam to be produced on a respective support structure of the first bipolar plate layer and on a respective support structure of the second bipolar plate layer;

FIG. 11 shows a schematic longitudinal section through clamping tools that are supported on bowl-shaped support structures, which are formed on the first bipolar plate layer and on the second bipolar plate layer, and on planar regions of the first bipolar plate layer and the second bipolar plate layer located between the support structures, along line 11-11 in FIG. 10;

FIG. 12 shows a schematic section corresponding to FIG. 10 through the bipolar plate layers and the clamping tools supported on support structures of the bipolar late layers, wherein, on the side located to the left of the connection seam in FIG. 12, such support structures are formed only on the first bipolar plate layer;

FIG. 13 shows a schematic longitudinal section corresponding to FIG. 11 through the clamping tools and the support structures formed on the first bipolar plate layer, along line 13-13 in FIG. 12;

FIG. 14 shows a partial plan view of a medium distribution region of a second embodiment of a bipolar plate, wherein web-shaped support structures of a medium flow field extend obliquely to portions of a connection seam of the bipolar plate;

FIG. 15 shows a plan view of the rear side of the region of the bipolar plate from FIG. 14, wherein web-shaped support structures of a medium flow field extend in parallel to the portions of the connection seam of the bipolar plate; and

FIG. 16 shows a partial longitudinal section through the bipolar plate from FIGS. 15 and 16, along line 16-16 in FIG. 14, wherein the course of the section plane in FIG. 15 is denoted by the line 16′-16′.

### DETAILED DESCRIPTION OF THE INVENTION

The same or functionally equivalent elements are provided with the same reference numerals in all Figures.

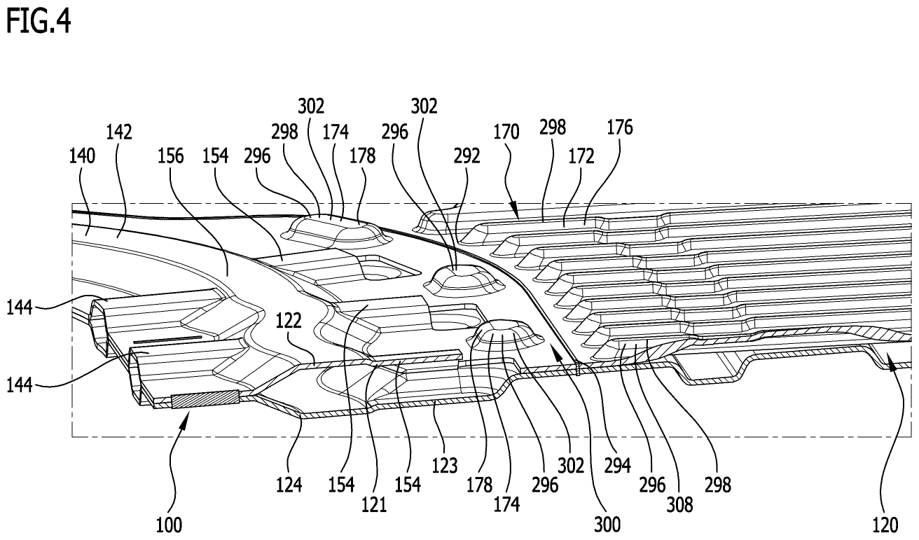

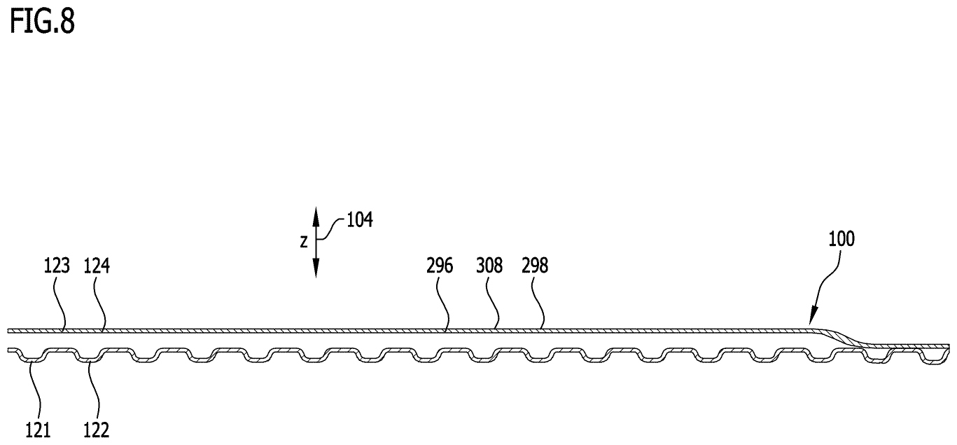

A bipolar plate, depicted in FIGS. 1 to 9 and denoted as a whole with 100, forms a constituent part of an electrochemical unit 102 (not depicted as a whole) which, in addition to the bipolar plate 100, may comprise a membrane-electrode arrangement, gas diffusion layers, and a seal arrangement.

A plurality of such electrochemical units 102 follow one another along a stack direction 104 to form a stack of electrochemical units 102, which is a constituent part of an electrochemical device 106, for example a fuel cell device.

The bipolar plate 100 has a substantially rectangular shape, wherein long sides 107 of the bipolar plate 100 extend along a longitudinal direction 108 and short sides 109 of the bipolar plate 100 extend along a transverse direction 110 of the bipolar plate 100.

The longitudinal direction 108 and the transverse direction 110 are preferably oriented perpendicularly to one another and perpendicularly to the stack direction 104.

The longitudinal direction 108 is also referred to as the x-direction, the transverse direction 110 is referred to as the y-direction, and the stack direction 104 is referred to as the z-direction.

The x-direction, the y-direction, and the z-direction span a right-angled coordinate system.

The bipolar plate 100 has two end regions 112 and an electrochemically active region 114 located between the end regions 112.

The electrochemically active region 114 of the bipolar plate 100 comprises an anode gas flow field 116 that is able to be flowed through by an anode gas, a cathode gas flow field 118 that is able to be flowed through by a cathode gas, and a coolant flow field 120 that is able to be flowed through by a coolant.

In the embodiment described here, the bipolar plate 100 is of two-layer configuration and comprises a first bipolar plate layer 121 and a second bipolar plate layer 123.

In the graphically depicted embodiment, the first bipolar plate layer 121 is an anode-side bipolar plate layer 122 on which the anode gas flow field 116 is formed, and the second bipolar plate layer 123 is a cathode-side bipolar plate layer 124 on which the cathode gas flow field 118 is formed.

In principle, the first bipolar plate layer 121 may be a cathode-side bipolar plate layer 124 and the second bipolar plate layer 123 may be an anode-side bipolar plate layer 122.

The bipolar plate layers 121 and 123 consist of a material that has good electrical conductivity, preferably a metallic material.

The bipolar plate layers 121 and 123 are connected to another by a material joint, preferably welded, along connection seams 294, in particular by laser welding.

The anode flow field 116 of the bipolar plate 100 is in fluidic connection with an anode-side electrode of a membrane-electrode arrangement, optionally by way of an anode-side gas diffusion layer.

The cathode flow field 118 of the bipolar plate 100 is in fluidic connection with a cathode-side electrode of a membrane-electrode arrangement, optionally by way of a cathode-side gas diffusion layer.

Anode gas and cathode gas can thus travel from the electrochemically active region 114 of the bipolar plate 100 to the electrochemically active regions of a respective membrane-electrode arrangement. Therefore, the region of the bipolar plate 100 provided with the anode gas flow field 116 and the cathode gas flow field 118 is referred to as its electrochemically active region 114, although no electrochemical reactions take place on the bipolar plate 100 itself.

The anode gas flow field 116 comprises anode gas flow channels 126, the main flow direction of which is oriented in parallel with the longitudinal direction 108 (x-direction) of the bipolar plate 100.

The cathode gas flow field 118 comprises cathode gas flow channels 128, the main flow direction of which extends in parallel with the longitudinal direction 108 (x-direction) of the bipolar plate 100.

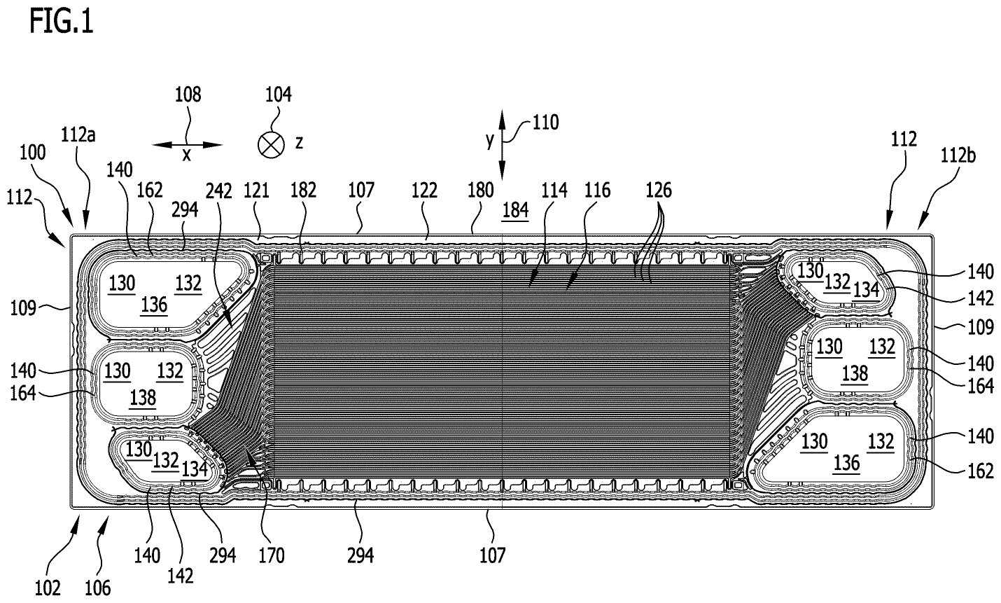

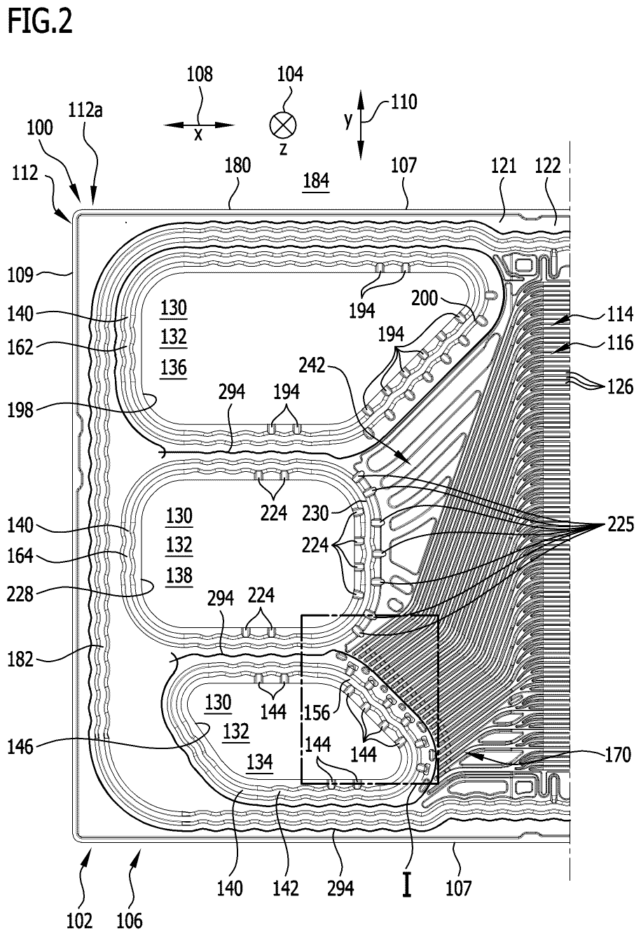

In its end regions 112, of which a first end region 112a is depicted in FIGS. 2 to 9, the bipolar plate 100 has in each case a plurality of medium passage openings 130 through which a respective fluid medium to be supplied to the electrochemical device 106 (an anode gas (combustion gas, for example hydrogen), a cathode gas (oxidizer, for example oxygen or air), or a coolant (for example water)) is able to pass through the bipolar plate 100. The medium passage openings 130 of the bipolar plates 100 following one another in the stack of electrochemical units 102 and the interspaces located between the medium passage openings 130 in the stack direction 104 together form a respective medium channel 132.

Associated with each of the medium channels 132 in one of the end regions 112 of the bipolar plate 100, through which a fluid medium is suppliable to the electrochemical device 100, is a respective other medium channel 132 in the respective opposite end region 112, through which the respective fluid medium is dischargeable from the electrochemical device 106.

The fluid media hereby travel through the anode gas flow field 116, the cathode gas flow field 118, and the coolant flow field 120 in the electrochemically active region 114 of the bipolar plate 100 from the one end region 112 to the other end region 112.

Arranged in the first end region 112a of the bipolar plate 100 depicted in FIGS. 2 to 9 are an anode gas passage opening 134, a cathode gas passage opening 136, and a coolant passage opening 138.

In principle, each of these passage openings 134, 136, and 138 may hereby selectively serve to supply the respective medium to the electrochemical device 106 or to discharge the respective medium from the electrochemical device 106.

In principle, each of the three media (anode gas, cathode gas, and coolant) can flow through the electrochemically active region 114 in parallel to the respective other media or with an opposite main flow direction relative to the main flow directions of one or two of the other media.

In a preferred embodiment of the invention, provision is made that all passage openings 134, 136, and 138 arranged in the first end region 112a of the bipolar plate 100 serve to supply the respective medium to the electrochemical device 106 and the passage openings 134, 136, and 138 arranged in the second end region 112b of the bipolar plate 100 serve to discharge the respective medium from the electrochemical device 106.

In order to prevent undesired leakage of the fluid media out of the respectively associated passage openings 134, 136, and 138, each of these passage openings is provided with a respective sealing bead 140.

The anode gas passage opening 134 is surrounded by an anode gas sealing bead 142.

In order to be able to supply the anode gas from the anode gas passage opening 134 to the anode gas flow field 136, the anode gas sealing bead 142 is provided with a plurality of anode gas inlets 144 on its inner side facing toward the anode gas passage opening 134, through which anode gas inlets anode gas is able to flow from the anode gas passage opening 134 into the interior space of the anode gas sealing bead 142 (see FIG. 2).

The anode gas inlets 144 each open on a rim 146 of the anode gas passage opening 134.

In the graphically depicted embodiment, the rim 146 of the anode gas passage opening 134 is of quadrangular configuration; the polygonal rim 146 of the anode gas passage opening 134 may also have more or fewer than four corners.

The corners of the anode gas passage opening 134 are preferably of rounded configuration in order to prevent tearing of the bipolar plate layers 122 and 124 in the region of said corners.

In order to enable the exit of the anode gas from the interior space of the anode gas sealing bead 142, the anode gas sealing bead 142 is provided with a plurality of anode gas outlets 154 on its outer side facing away from the anode gas passage opening 134.

The anode gas outlets 154 are preferably arranged on a portion 156 of the anode gas sealing bead 142 that faces toward the electrochemically active region 114 of the bipolar plate 100.

The anode gas inlets 144 that are arranged on the same portion 156 of the anode gas sealing bead 142 are preferably offset relative to the anode gas outlets 154 along the peripheral direction of the anode gas sealing bead 142.

The anode gas flows through the anode gas outlets 154 on the portion 156 of the anode gas sealing bead 142 into an anode gas distribution region 170, which serves to distribute the anode gas as uniformly as possible to the anode gas flow channels 126 of the anode gas flow field 116.

The anode gas distribution region 170 comprises a plurality of respective directed distribution structures 172 and a plurality of respective undirected distribution structures 174, which serve to deflect the anode gas from its original flow direction.

The directed distribution structures 172 are hereby configured, e.g., as substantially linearly extending distribution webs 176.

The undirected distribution structures 174 are configured, e.g., as substantially bowl-shaped distribution nubs 178.

The distribution structures 172 and 174, like all other structures of the bipolar plate 100 described in the preceding and in the following, are preferably formed in one piece with the material of the bipolar plate layers 121 or 123 and are introduced into the respective bipolar plate layer 121 and 123 by a reshaping operation, for example by a stamping operation or a deep-drawing operation.

The cathode gas passage opening 136 is surrounded by a cathode gas sealing bead 162.

The coolant passage opening 138 is surrounded by a coolant sealing bead 164.

An annularly closed rim bead 182 extends around near the outer rim 180 of the bipolar plate 100.

The rim bead 182 encloses the electrochemically active region 114 of the bipolar plate 100, the anode gas passage openings 134, and the anode gas sealing beads 142 in both end regions 112, the cathode gas passage openings 136 and the cathode gas sealing beads 162 in both end regions 112, and the coolant passage openings 138 and the coolant sealing beads 164 in both end regions 112 of the bipolar plate 100.

The rim bead 182 serves to prevent leakage of the media to be supplied to the electrochemical device 106, in particular the anode gas, the cathode gas, and the coolant, from the electrochemical units 102 into the outside space 184 of the electrochemical device 106.

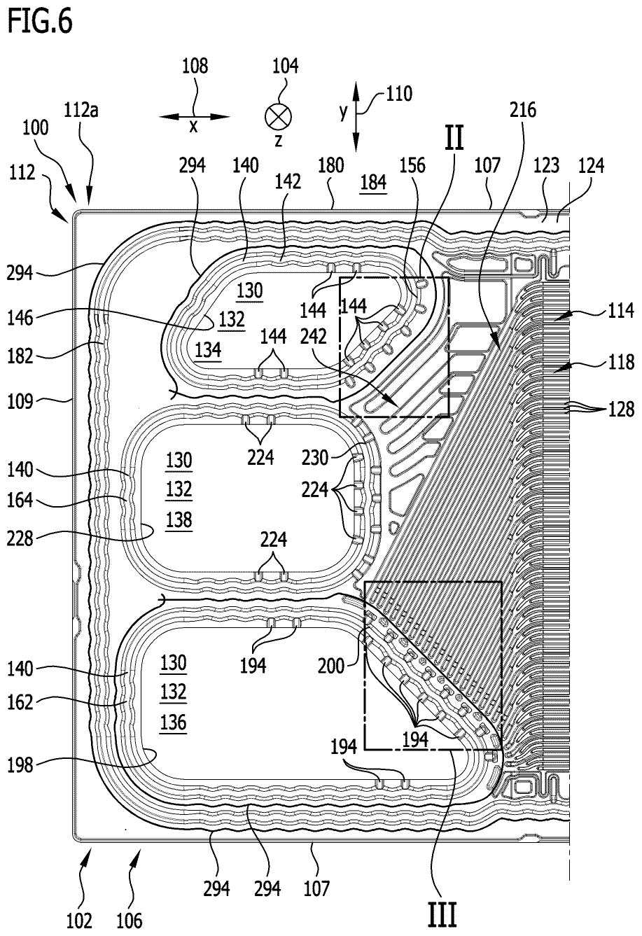

In order to allow the cathode gas to flow out of the cathode gas passage opening 136 through the cathode gas sealing bead 162, the cathode gas sealing bead 162 is provided with a plurality of cathode gas inlets 194 on its inner side facing toward the cathode gas passage opening 136 (see in particular FIG. 6).

Cathode gas travels from the cathode gas passage opening 136 through the cathode gas inlets 194 into the interior space of the cathode gas sealing bead 162.

The cathode gas inlets 194 preferably open on the rim 198 of the cathode gas passage opening 136.

In the graphically depicted embodiment, the rim 198 of the cathode gas passage opening 136 is of quadrangular configuration. The number of corners of the polygonal rim 198 may also be smaller or greater than four.

Cathode gas outlets 214 that are arranged on the outer side of the cathode gas sealing bead 162 facing away from the cathode gas passage opening 136 and through which the cathode gas flows out of the interior space of the cathode gas sealing bead 162 are preferably all arranged on a portion 200 of the cathode gas sealing bead 162 that faces toward the electrochemically active region 114 of the bipolar plate 100.

The cathode gas inlets 194 that are arranged on the same portion 200 of the cathode gas sealing bead 162 are preferably arranged offset relative to the cathode gas outlets 214 along the peripheral direction of the cathode gas sealing bead 162.

Preferably, a total of two or more cathode gas outlets 214, in particular four or more, particularly preferably six or more, namely eight in the embodiment depicted, are provided on the cathode gas sealing bead 162.

The cathode gas flows through the cathode gas outlets 214 into a cathode gas distribution region 216 of the bipolar plate 100, which serves to distribute the cathode gas as uniformly as possible to the cathode gas flow channels 128 of the cathode gas flow field 118.

For this purpose, the cathode gas distribution region comprises distribution structures 218, which are configured as directed distribution structures 220 or as undirected distribution structures 221.

The directed distribution structures 220 are preferably configured as linearly extending distribution webs 222.

The undirected distribution structures 221 are configured, e.g., as substantially bowl-shaped distribution nubs 223.

In order to allow the coolant to flow out of the coolant passage opening 138 into the coolant flow field 120 of the bipolar plate 100, the coolant sealing bead 164 is provided with a plurality of coolant inlets 224 on its inner side facing toward the coolant passage opening 138 (see in particular FIGS. 2 and 6).

The coolant travels from the coolant passage opening 138 through the coolant inlets 224 into the interior space of the coolant sealing bead 164.

The rim 228 of the coolant passage opening 138 is of quadrangular configuration in the graphically depicted embodiment. The number of corners of the polygonal rim 228 of the coolant passage opening 138 may also be greater or smaller than four.

Coolant outlets 225 that are arranged on the outer side of the coolant sealing bead 164 facing away from the coolant passage opening 138 and through which the coolant flows out of the interior space of the coolant sealing bead 164 are preferably all arranged on a portion 230 of the coolant sealing bead 164 that faces toward the electrochemically active region 114 of the bipolar plate 114.

The coolant inlets 224 that are arranged on the same portion 230 of the coolant sealing bead 164 are preferably arranged offset relative to the coolant outlets 225 along the peripheral direction of the coolant sealing bead 164.

The coolant flows through the coolant outlets 225 into a coolant distribution region 242 of the bipolar plate 100, which serves to distribute the coolant as uniformly as possible to the coolant flow channels of the coolant flow field.

In this coolant distribution region 242, the anode-side bipolar plate layer 122 and the cathode-side bipolar plate layer 124 are arranged offset in opposite directions along the stack direction 104 relative to a longitudinal central plane of the bipolar plate 100 oriented perpendicularly to the stack direction 104, in such a way that a large cross-section that is able to be flowed through is available for the flow of the coolant through the coolant distribution region 242.

The bipolar plate 100 is preferably of rotationally symmetrical configuration with respect to a rotation by 180° about a rotational axis extending through the midpoint of the electrochemically active region 114 of the bipolar plate 100 and in parallel to the stack direction 104 (z-direction).

The medium passage openings 130 arranged in the second end region 112b, in particular the anode gas passage opening 134 arranged there, the cathode gas passage opening 136 arranged there, and the coolant passage opening 138 arranged there, are therefore preferably structured and arranged substantially identically to the anode gas passage opening 134, the cathode gas passage opening 136, and the coolant passage opening 138, respectively, in the first end region 112a, which have been described above.

Because the bipolar plate 100 described above and depicted in FIGS. 1 to 9 is of multi-layer configuration, the first bipolar plate layer 121 and the second bipolar plate layer 123 must be connected to one another sealed in a fluid-tight manner along the connection seam 294 in order to prevent one of the media to be supplied to the electrochemical device 106 (anode gas, cathode gas, coolant) from traveling through gaps between the first bipolar plate layer 121 and the second bipolar plate layer 123 to a medium passage opening 130 of another medium or into a medium distribution region or medium flow field of another medium.

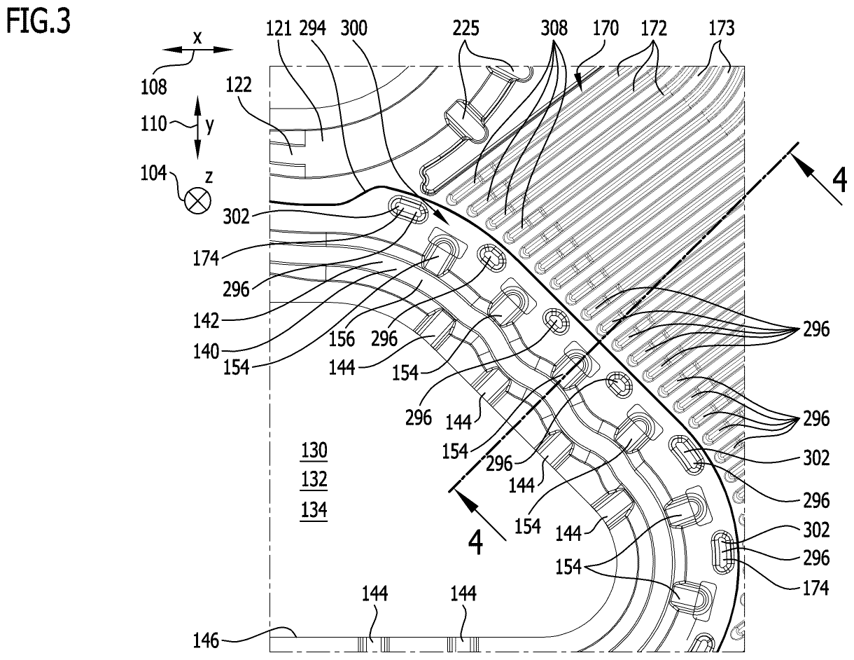

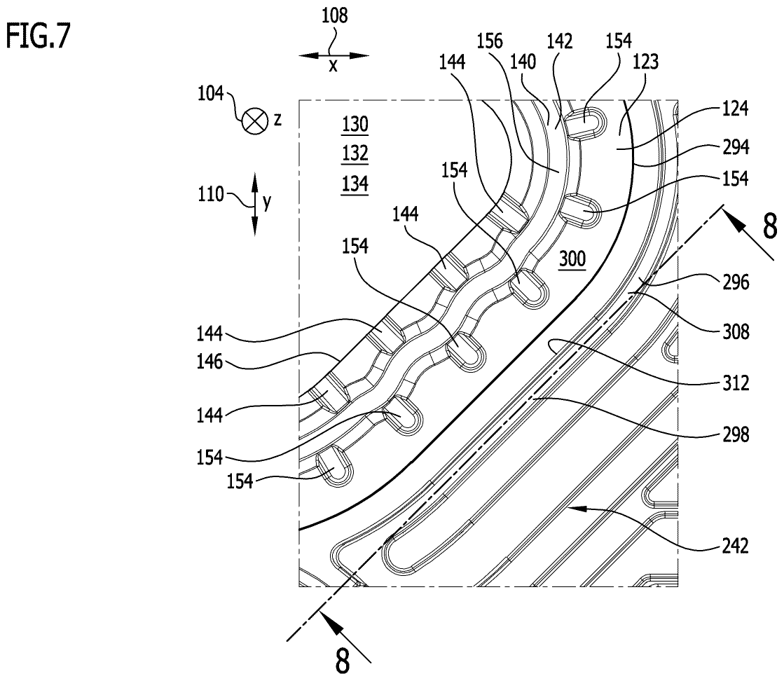

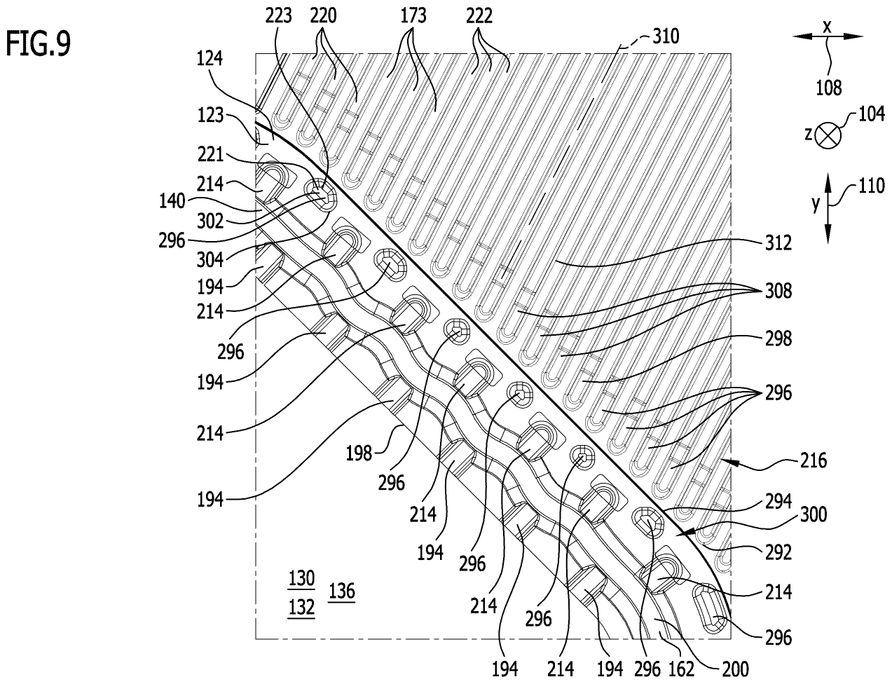

Such connection seams 294 at which the first bipolar plate layer 121 and the second bipolar plate layer 123 are connected to one another by a material joint, preferably by welding, in particular by laser welding, are arranged, for example, in the region between the outer side of the anode gas sealing bead 142 on the one hand and the anode gas distribution region 170 on the other hand (see in particular FIGS. 3 to 5) as well as between the cathode gas sealing bead 162 on the one hand and the cathode gas distribution region 216 on the other hand (see in particular FIG. 9) and between the anode gas sealing bead 142 on the one hand and the coolant distribution region 242 on the other hand (see in particular FIG. 7).

As can be seen in FIGS. 3 to 5, for example, formed preferably on both sides of the connection seam 294 are support structures 296, which during the production of the connection seam 294 serve to support clamping tools that are in contact with supporting faces 298 of the support structures 296 and optionally also in contact with planar contact regions 300 of the bipolar plate layers 121, 123 located between the support structures 296 in order to press the first bipolar plate layer 121 and the second bipolar plate layer 123 against one another with a sufficient clamping force during the connecting operation, in particular a welding operation. As a result, it is achieved that at most a “technical zero gap” of less than 0.03 mm height (along the stack direction 104) remains between the two bipolar plate layers 121, 123 before the connecting operation.

As can be seen in FIGS. 3 to 5, the support structures 296 on the side of the connection seam 294 facing toward the sealing bead 140 (anode gas sealing bead 142) are formed by the aforementioned undirected distribution structures 174 in the form of distribution nubs 178.

These nub-shaped support structures 302 each have a supporting face 298, which is oriented perpendicularly to the stack direction 104 (z-direction) of the bipolar plate 100 and, relative to the surface 299 of the first bipolar plate layer 121 on which these nub-shaped support structures 302 are formed by reshaping, is offset in the planar contact region 300, in which the two bipolar plate layers 121 and 123 abut in surface-to-surface contact against one another, along the stack direction 104 (z-direction) of the bipolar plate 100 away from the second bipolar plate layer 123.

The supporting face 298 of the bowl-shaped support structures 302 preferably has a smallest extent a perpendicular to the stack direction 104 (z-direction) of the bipolar plate 100 which is at least 0.1 mm, in particular at least 0.5 mm.

Furthermore, the smallest extent a of the supporting faces 298 of said bowl-shaped support structures 302 perpendicular to the stack direction 104 (z-direction) of the bipolar plate 100 is preferably at most 3 mm, in particular at most 1.5 mm.

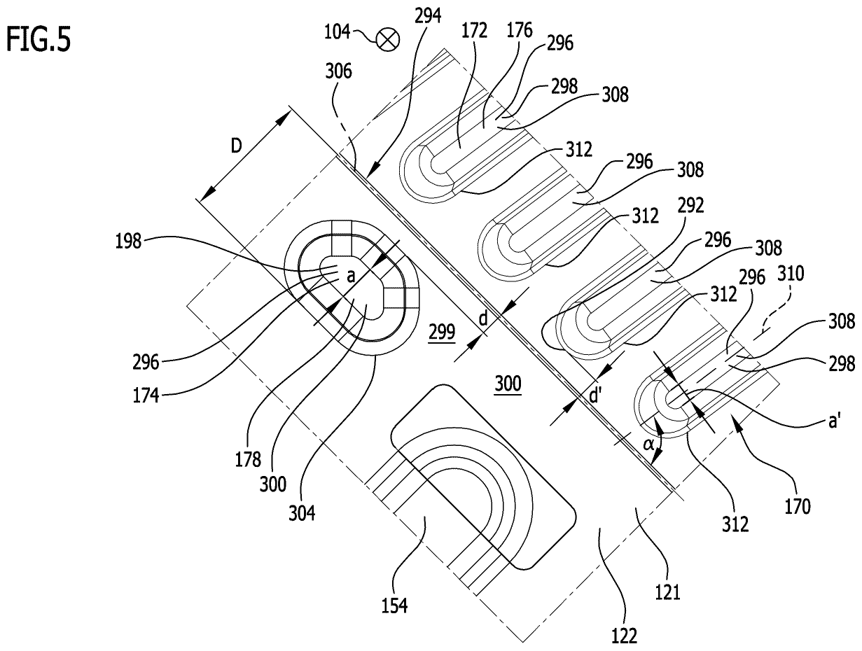

As can further be seen in FIG. 5, each of the bowl-shaped support structures 302 has a rim 304 at which the respective support structure 302 transitions into a planar region of the first bipolar plate layer 121 on which the support structures 302 are formed, wherein the smallest distance d, taken perpendicularly to the center line 306 of the connection seam 294, of the rim 304 of the respective support structure 296 from the center line 306 of the connection seam 294 is at most 0.8 mm, in particular at most 0.5 mm, particularly preferably at most 0.3 mm.

The greatest distance D, taken perpendicularly to the center line 306 of the connection seam 294, of the rim 304 of the respective support structure 296 from the center line 306 of the connection seam 294 is preferably at most 5 mm, in particular at most 3 mm, particularly preferably at most 2 mm.

As can further be seen in FIGS. 3 to 5, the support structures 296 on the side of the connection seam 294 facing away from the sealing bead 140 (anode gas sealing bead 142) are formed by the directed distribution structures 172 of the anode distribution region 170 in the form of the distribution webs 176.

These web-shaped support structures 308 also each comprise a respective supporting face 298, the smallest extent a′ of which perpendicular to the stack direction 104 (z-direction) of the bipolar plate 100 is preferably at least 0.1 mm, in particular at least 0.5 mm.

The web-shaped support structures 308 have their greatest extent perpendicular to the stack direction 104 (z-direction) of the bipolar plate 100 along their longitudinal direction 310, and this greatest extent is preferably greater than 3 mm, in particular greater than 5 mm.

The web-shaped support structures 308 extend transversely to the connection seam 294, and their ends 292 pointing toward the sealing bead 140 (anode gas sealing bead 142) are preferably at a distance d′, taken perpendicularly to the center line 306 of the connection seam 294, from the center line 306 of the connection seam 294 which is less than 0.8 mm, in particular less than 0.5 mm, particularly preferably less than 0.3 mm.

The ends 292 of the web-shaped support structures 308 lie on a rim 312 of the respective support structure 296 at which the support structure 296 transitions into a planar region of the first bipolar plate layer 121 on which the support structure 296 is formed, wherein smallest distance d′, taken perpendicularly to the center line 306 of the connection seam 294, of the rim 312 of the support structure 296 from the center line 306 of the connection seam 294 is preferably at most 0.8 mm, in particular at most 0.5 mm, particularly preferably at most 0.3 mm.

In the operating state of the electrochemical device 106, adjacent components of electrochemical units 102 are supported on the supporting faces 298 of the support structures 296, for example gas diffusion layers or sub-gaskets of membrane electrode units of electrochemical units 102.

The distances between these supporting faces 298 thus should not be too large in order to prevent these adjacent components of electrochemical units 102 from sagging in the regions between the supporting faces 298 and reducing the cross-sections able to be flowed through that are present there.

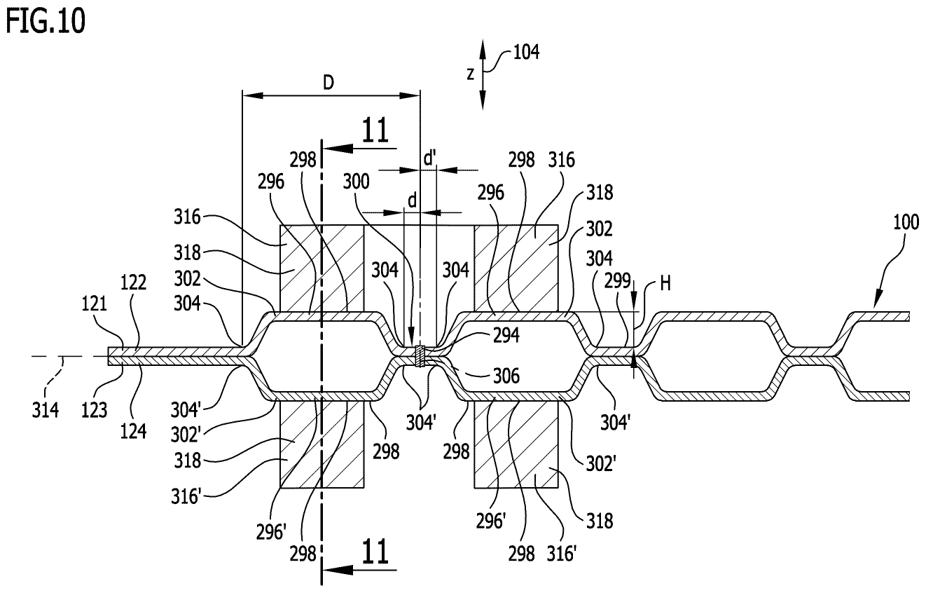

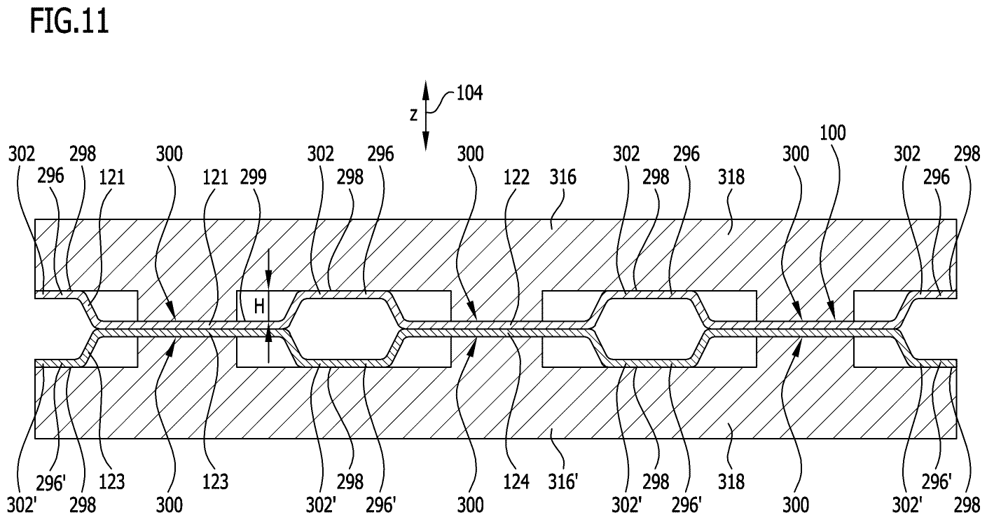

A method for connecting the first bipolar plate layer 121 and the second bipolar plate layer 123 by a material joint is discussed in the following with reference to FIGS. 10 and 11.

The schematic depictions of FIGS. 10 and 11 hereby refer to a case in which bowl-shaped support structures 302 are arranged on the first bipolar plate layer 121 on both sides of the connection seam 294 to be produced and at positions which are substantially congruent with the positions of the bowl-shaped support structures 302 on the first bipolar plate layer 121 or are only slightly offset from these positions, bowl-shaped support structures 302′ are also arranged on the second bipolar plate layer 123.

The first support structures 296 formed on the first bipolar plate layer 121 each have a first rim 304 at which these first support structures 296 transition into a planar region of the first bipolar plate layer 121, and the second support structures 296′ formed on the second bipolar plate layer 123 each have a second rim 304′ at which the second support structures 296′ transition into a planar region of the second bipolar plate layer 123, wherein the first rims 304 and the second rims 304′ are substantially congruent with one another or deviate from one another by a distance of at most 0.5 mm, taken perpendicularly to the longitudinal direction of the respective first rim 304 or the respective second rim 304′, in a projection onto a plane 314 oriented perpendicularly to the stack direction 104 (z-direction) of the bipolar plate 100.

The configuration of the support structures 296, which is depicted in FIGS. 10 and 11, thus differs from the concrete configuration of the support structures 296 as depicted in FIGS. 3 to 5 for the region between the anode gas sealing bead 142 and the anode gas distribution region 170; however, apart from the concrete configuration of the clamping tools 316 used for performing the connecting method, this does not result in any fundamental deviations.

First, the first bipolar plate layer 121 and the second bipolar plate layer 123 are arranged such that they are in contact with one another, preferably in surface-to-surface contact, at one or more contact regions 300.

By means of a plurality of clamping tools 316, 316′, a clamping force is applied to the first bipolar plate layer 121 and the second bipolar plate layer 123, by means of which the first bipolar plate layer 121 and the second bipolar plate layer 123 are pressed against one another in the contact regions 300, such that at most a “technical zero gap” with a height (extent along the stack direction 104) of less than 0.03 mm remains in the contact regions 300.

The clamping tools 316 abut against supporting faces 298 of the support structures 296, which, relative to the surface 299 of the bipolar plate layer 121 on which the support structures 296 are formed, are offset in the contact regions 300 by a height H along the stack direction 104 away from the respective other bipolar plate layer 123.

Here, the smallest distances d, d′ of the rims 304, 304′ of the support structures 296, 296′ from the center line 306 of the connection seam 294 to be produced are so small, preferably at most 0.8 mm, in particular at most 0.5 mm, particularly preferably at most 0.3 mm, that the clamping forces introduced along the rims 304, 304′ into the contact regions 300 of the bipolar plate layers 121, 123 are high enough to produce a stable clamping effect between the bipolar plate layers 121 and 123 in the planar contact regions 300.

As can best be seen in the longitudinal section of FIG. 11, the clamping tools 316, 316′, which in the embodiment shown are configured as clamping webs 318 extending in a longitudinal direction, abut both against the supporting faces 298 of the support structures 296 and, in the respective regions between two support structures 296 following one another along the longitudinal direction of a clamping tool 316, 316′, against a respective planar contact region 300 of the first bipolar plate layer 121 and the second bipolar plate layer 123 respectively in order to transmit clamping forces to the bipolar plate layer 121, 123 at each of these areas.

While the clamping forces are applied to the bipolar plate layers 121, 123 by means of the clamping tools 316, the first bipolar plate layer 121 and the second bipolar plate layer 123 are connected to one another by a material joint along the connection seam 294, preferably by welding, for example by laser welding.

Here, a laser for producing a connection seam 294 by means of laser welding may be arranged on the side of the first bipolar plate layer 121 facing away from the second bipolar plate layer 123 or on the side of the second bipolar plate layer 123 facing away from the first bipolar plate layer 121.

After producing the connection seam 294, the clamping tools 316, 316′ are released from the bipolar plate layers 121, 123.

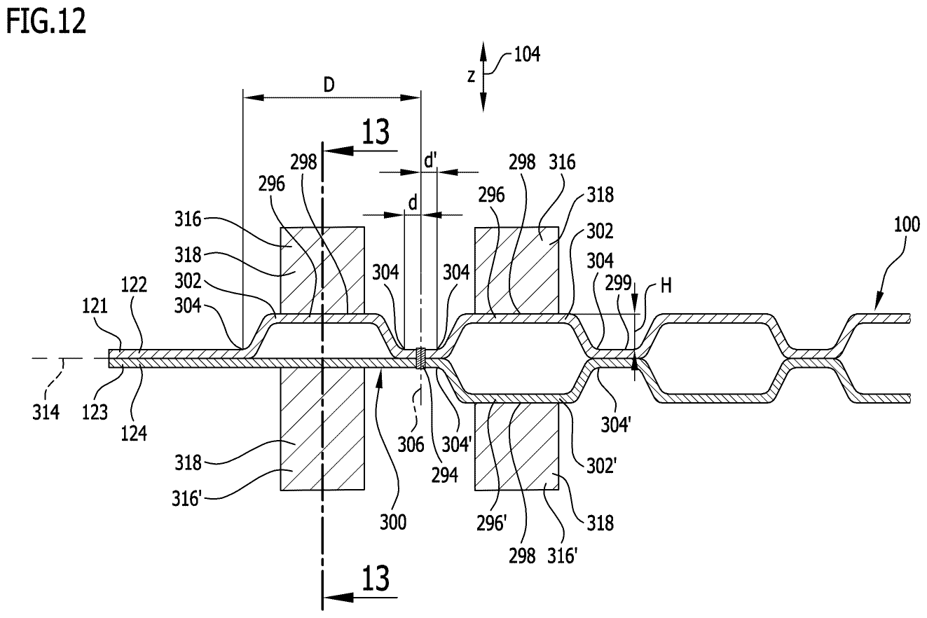

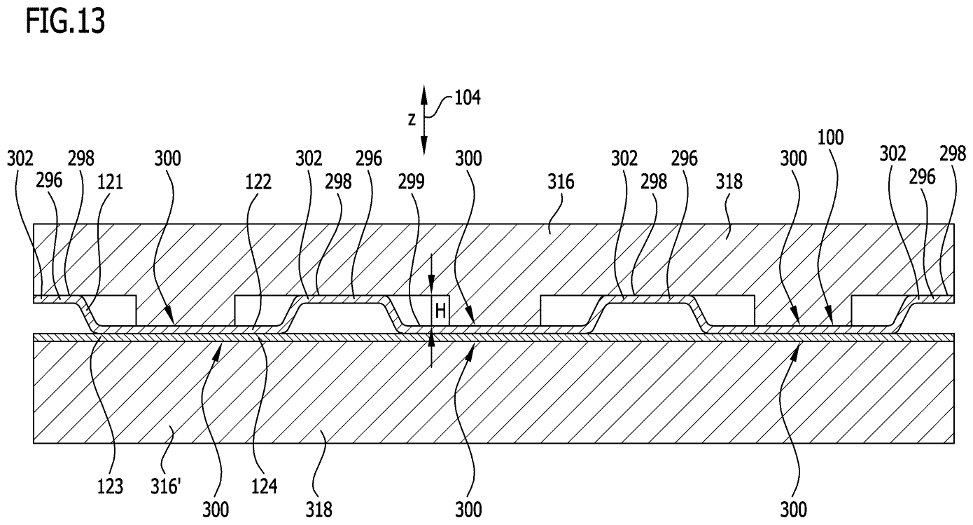

A second embodiment depicted in FIGS. 12 and 13 of a method for connecting the first bipolar plate layer 121 and the second bipolar plate layer 123 by a material joint differs from the first embodiment depicted in FIGS. 10 and 11 in that no support structures 296′ for a clamping tool 316′ are provided on the second bipolar plate layer 123 to the left of the connection seam 294 to be produced, but instead in this region the clamping tool 316′ abuts against a planar region of the second bipolar plate layer 123.

As can be seen in the longitudinal section of FIG. 13, this clamping tool 316′ thus has the same cross-section everywhere in its longitudinal direction and thus has a substantially cuboidal shape overall.

In all other respects, the second embodiment depicted in FIGS. 12 and 13 for connecting the first bipolar plate layer 121 and the second bipolar plate layer 123 by a material joint corresponds to the first embodiment depicted in FIGS. 10 and 11, to the preceding description of which reference is made in this regard.

As can be seen in FIGS. 6 and 9, the cathode gas sealing bead 162 is surrounded by a closed connection seam 294.

As can best be seen in FIG. 9, like in the case of the connection seam 294 surrounding the anode gas sealing bead 142 described above, support structures 296 for supporting clamping tools 316 during the production of the connection seam 294 are provided on both sides of the connection seam 294.

Here, the support structures 296 arranged on the side of the connection seam 294 facing toward the sealing bead 140 (cathode gas sealing bead 162) are configured as bowl-shaped support structures 302 molded into the second bipolar plate layer 123, while the support structures 296 arranged on the side of the connection seam 294 facing away from the sealing bead 140 (cathode gas sealing bead 162) are configured as web-shaped support structures 308 molded into the second bipolar plate layer 123, the longitudinal direction 310 of which extends transversely to the center line 306 of the connection seam 294. The longitudinal direction 310 preferably encloses an angle a of more than 75°, in particular more than 80°, with the center line 306 of the connection seam 294.

In all other respects, the support structures 296 on both sides of the connection seam 294 surrounding the cathode gas sealing bead 162 corresponds with respect to structure, function, and production method with the support structures 296 on both sides of the connection seam 294 surrounding the anode gas sealing bead 142, to the preceding description of which reference is made in this regard.

The method for connecting the first bipolar plate layer 121 and the second bipolar plate layer 123 by a material joint along the connection seam 294 surrounding the cathode gas sealing bead 162 corresponds, aside from the first bipolar plate layer 121 and the second bipolar plate layer 123 being switched with one another, to the method described above with reference to FIGS. 10 to 13, to the preceding description of which reference is made in this regard.

As can be seen in FIGS. 6 and 7, on the cathode side of the bipolar plate 100 along the connection seam 294 surrounding the anode gas sealing bead 142, on the side facing away from the sealing bead (anode gas sealing bead 142), a support structure 296 is provided which extends in parallel to the connection seam 294.

This web-shaped support structure 308 may serve to support a clamping tool 316 during the production of the connection seam 294.

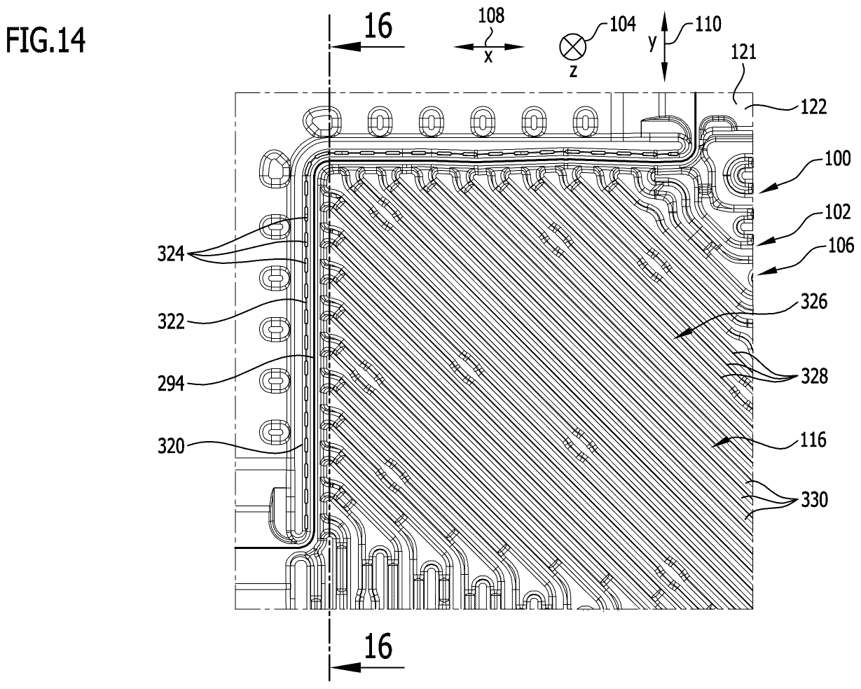

The second embodiment depicted in FIGS. 14 to 16 of a bipolar plate 100 in which a connection seam 294, along which a first bipolar plate layer 121 and a second bipolar plate layer 123 are connected to one another by a material joint, extends in parallel to a bead 320 at least in sections, on the flank 322 of which facing toward the connection seam 294 a plurality of medium outlet openings 324 are arranged.

Arranged on the side of the connection seam 294 facing away from the bead 320 is a medium flow field 326, which has webs 328 that extend at an angle of about 45° relative to the longitudinal direction of the connection seam 294.

Arranged between two respective webs 328 is a respective medium flow channels 330, into which medium flowing out of the medium outlet openings 324 of the bead 320 flows.

Here, the medium flow field 326 depicted in FIG. 14 may be, e.g., the anode gas flow field 116 of the bipolar plate 100.

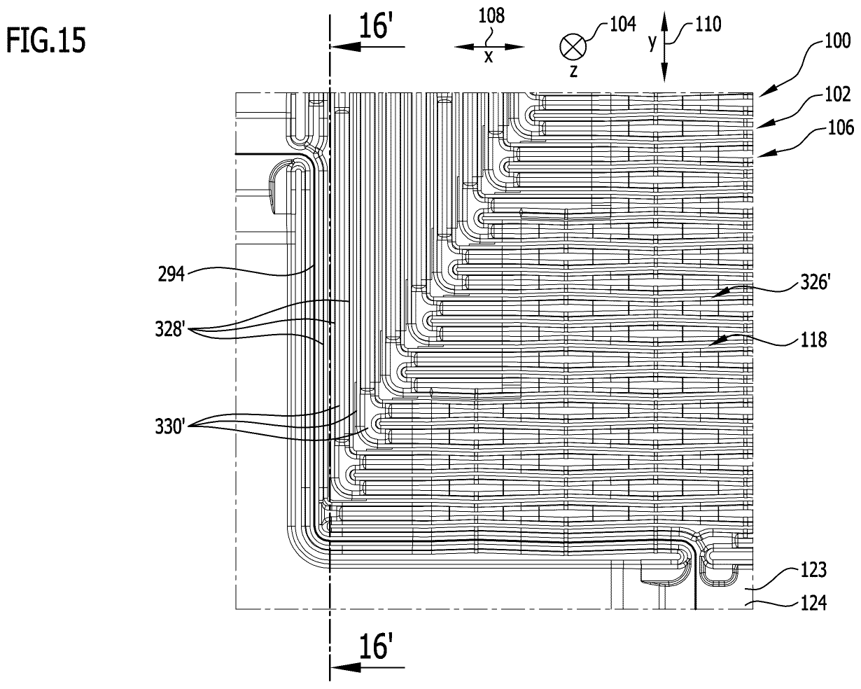

FIG. 15 shows the rear side of the bipolar plate 100 in the region depicted in FIG. 14 and thus a medium flow field 326′ that is associated with another medium to be supplied to the electrochemical device 106.

If FIG. 14 shows the anode gas flow field 116, FIG. 15 thus shows the cathode gas flow field 118 of the bipolar plate 100.

The anode side and the cathode side of the bipolar plate 100 may also be switched with one another.

As can be seen in FIG. 15, the webs 328 of the medium flow field 326′ extend in parallel to the connection seam 294 at least in sections.

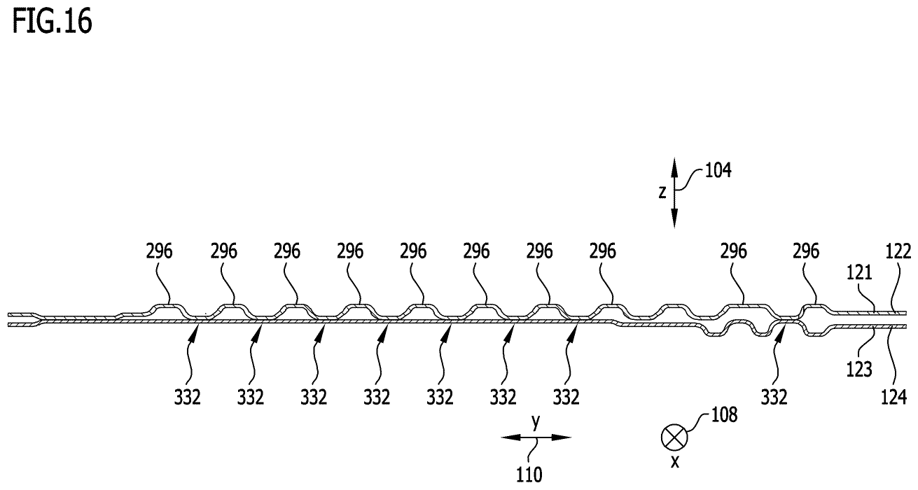

The medium channels 330′ of the medium flow field 326′ and the medium channels 330 of the medium flow field 326 thus intersect, which creates a sequence of local contact centers 332 in parallel to the connection seam 294, at which contact centers the first bipolar plate layer 121 and the second bipolar plate layer 123 are supported on one another, such that a balance of forces is created at these local contact centers 332 when the bipolar plate layers 121 and 123 are pressed, and raised portions adjacent to these local contact centers 332 in the first bipolar plate layer 121 or second bipolar plate layer 123 can serve as support structures 296 for supporting clamping tools 316 (see FIG. 16).

In this embodiment of the bipolar plate 100, too, the method described above with reference to FIGS. 10 to 13 for connecting the first bipolar plate layer 121 and the second bipolar plate layer 123 by a material joint can be performed by means of clamping tools 316, which are supported on support structures 296 that are molded into the first bipolar plate layer 121 or into the second bipolar plate layer 123.

1. A method for connecting, by a material joint, a first bipolar plate layer and a second bipolar plate layer of a bipolar plate for an electrochemical unit of an electrochemical device comprising a plurality of electrochemical units that follow one another along a stack direction, wherein the method comprises the following:
bringing the first bipolar plate layer and the second bipolar plate layer into contact with one another at one or more contact regions of the bipolar plate layers;
applying a clamping force to the first bipolar plate layer and the second bipolar plate layer by way of one or more clamping tools; and
connecting the first bipolar plate layer and the second bipolar plate layer by a material joint along a connection seam;
wherein at least one clamping tool is supported on a supporting face of at least one support structure of at least one of the bipolar plate layers, wherein the supporting face of the support structure, relative to the surface of the bipolar plate layer on which the support structure is formed, is offset in the contact region along the stack direction away from the respective other bipolar plate layer.

2. The method in accordance with claim 1, wherein at least one of the clamping tools is supported on a plurality of supporting faces of a plurality of different support structures and on a plurality of contact regions of the bipolar plate layers located between the support structures.

3. The method in accordance with claim 1, wherein at least one first clamping tool is supported on at least one first support structure formed on the first bipolar plate layer, and at least one second clamping tool is supported on at least one second support structure formed on the second bipolar plate layer.

4. The method in accordance with claim 3, wherein the first support structure has a first rim at which the first support structure transitions into a planar region of the first bipolar plate layer, and the second support structure has a second rim at which the second support structure transitions into a planar region of the second bipolar plate layer, wherein the first rim and the second rim are substantially congruent with one another or deviate from one another by a distance of at most 0.5 mm in a projection onto a plane oriented perpendicularly to the stack direction.

5. The method in accordance with claim 1, wherein at least one support structure is formed at a location of one of the bipolar plate layers, located opposite to which is a planar region of the respective other bipolar plate layer not provided with a support structure.

6. The method in accordance with claim 1, wherein the supporting face of at least one support structure has a smallest extent perpendicular to the stack direction which is at least 0.1 mm.

7. The method in accordance with claim 1, wherein the supporting face of at least one support structure has a smallest extent perpendicular to the stack direction which is at most 3 mm.

8. The method in accordance with claim 1, wherein the supporting face of at least one support structure has a greatest extent perpendicular to the stack direction which is greater than 3 mm.

9. The method in accordance with claim 1, wherein at least one support structure has a rim at which the support structure transitions into a planar region of the bipolar plate layer on which the support structure is formed,
wherein the smallest distance of the rim of the support structure from the center line of the connection seam is at most 0.8 mm.

10. The method in accordance with claim 1, wherein at least one support structure has a rim at which the support structure transitions into a planar region of the bipolar plate layer on which the support structure is formed,
wherein the greatest distance of the rim of the support structure from the center line of the connection seam is at most 5 mm.

11. The method in accordance with claim 1, wherein at least one support structure is of circular or oval configuration in a plan view along the stack direction.

12. The method in accordance with claim 1, wherein at least one support structure is of web-shaped configuration.

13. The method in accordance with claim 12, wherein the at least one web-shaped support structure extends substantially in parallel to the connection seam at least in sections.

14. The method in accordance with claim 12, wherein a plurality of web-shaped support structures extend transversely to the connection seam and end at a distance of less than 0.8 mm from the center line of the connection seam.

15. A bipolar plate for an electrochemical unit of an electrochemical device comprising a plurality of electrochemical units that follow one another along a stack direction,
wherein the bipolar plate comprises the following:
a first bipolar plate layer and a second bipolar plate layer, which are connected to one another by a material joint along a connection seam in a contact region of the bipolar plate layers;
wherein at least one respective support structure is formed on at least one of i) the first bipolar plate layer and ii) the second bipolar plate layer,
wherein a supporting face of the at least one support structure, relative to the surface of the bipolar plate layer on which the support structure is formed, is offset in the contact region along the stack direction away from the respective other bipolar plate layer and
wherein the at least one support structure has a rim at which the support structure transitions into a planar region of the bipolar plate layer on which the support structure is formed, wherein the smallest distance of the rim of the support structure from the center line of the connection seam is at most 0.8 mm.

16. An electrochemical device, comprising a plurality of electrochemical units that follow one another along a stack direction and each comprise a bipolar plate for an electrochemical unit of the electrochemical device,
wherein the bipolar plate comprises the following:
a first bipolar plate layer and a second bipolar plate layer, which are connected to one another by a material joint along a connection seam in a contact region of the bipolar plate layers;
wherein at least one respective support structure is formed on at least one of i) the first bipolar plate layer and ii) the second bipolar plate layer,
wherein a supporting face of the at least one support structure, relative to the surface of the bipolar plate layer on which the support structure is formed, is offset in the contact region along the stack direction away from the respective other bipolar plate layer and
wherein the at least one support structure has a rim at which the support structure transitions into a planar region of the bipolar plate layer on which the support structure is formed, wherein the smallest distance of the rim of the support structure from the center line of the connection seam is at most 0.8 mm.
